(19) United States
(12) Patent Application Publication
(10) Pub. No.: US 2020/0371501 A1
(43) Pub. Date: Nov. 26, 2020

(54) SYSTEMS AND METHODS FOR THE SECURE OPTIMIZATION OF AN INDUSTRIAL PROCESS

(71) Applicant: Nimbus LLC, Miami, FL (US)

(72) Inventors: William G. Thompson, Miami, FL (US); J. Adam Roth, Miami, FL (US)

(21) Appl. No.: 16/881,978

(22) Filed: May 22, 2020

Related U.S. Application Data
(60) Provisional application No. 62/852,563, filed on May 24, 2019.

(51) Int. Cl. G05B 19/418; G05B 23/02

(52) U.S. Cl. CPC G05B 19/4184; G05B 19/41875; G05B 23/027

(57) ABSTRACT

A method for managing a mechanized process includes receiving a signal from a hub module indicative of a detected parameter of a manufacturing device, determining with a local computing device communicatively coupled to the hub module, an improved parameter of the manufacturing device based at least in part on the detected parameter of the manufacturing device, and sending a signal to a user computing device to provide an option implement the improved parameter on the manufacturing device.

### CROSS-REFERENCE TO RELATED APPLICATIONS

This application claims the benefit of U.S. Provisional Patent Application 62/852,563 filed May 24, 2019, the contents of which are hereby incorporated by reference in their entirety.

### TECHNICAL FIELD

Embodiments described herein generally relate to systems and methods for managing and optimizing the operation of mechanized systems and, more specifically, to systems and methods for managing sensors, actuators, transducers, end devices, pneumatics, relays, and programmable logic controllers (PLC) within mechanized systems.

### BACKGROUND

Mechanized systems may be utilized to perform various tasks or produce various goods, and the mechanized systems generally include machines including sensors that detect various characteristics of processes carried out by the mechanized system. For example, humidity and temperature sensors may be utilized at various steps in the production of food and beverage products. In a bottle filling process, weight sensors may be utilized to confirm the amount of fluid dispensed into a bottle. Information received by these sensors is conventionally communicated to a machine controller, such as a programmable logic controller (PLC) or the like. The machine controller may also direct various actuators, transducers, pneumatics, and/or relays to perform the processes carried out by the mechanized system.

### BRIEF SUMMARY

However, conventional controllers may be configured as stand-alone controllers that do not allow a user to view information multiple machine controllers or sensors throughout a mechanized system. In particular, the isolated nature of stand-alone controllers may make it difficult to aggregate data from various sensors. Similarly, conventional stand-alone controllers generally do not allow a user to configure the operation of various actuators, transducers, pneumatics, and/or relays throughout the mechanized system from a single location. Accordingly, a need exists for alternative methods for managing, visualizing, diagnosing, and performing analytics on data acquired from sensors, actuators, transducers, pneumatics, and/or relays within a mechanized system.

However, conventional industrial processes are statically and subjectively programmed by controls engineers and may be unaltered for years. With changes in the industrial environment, degradation of equipment, and underperforming operations, automated optimization may increase the efficacy of both new and existing systems. In particular, predicting and solving for improved parameter values within a designated lower and upper constraint based upon data acquired from sensors, actuators, transducers, pneumatics, and/or relays within a mechanized system allows a user to identify how segments of a mechanized system or an entire mechanized system may be improved.

In one embodiment, a modular system for managing and optimizing operation of a mechanized process, the modular system including a hub module structurally configured to be non-invasively communicatively coupled to a manufacturing device, a user computing device, and a local computing device communicatively coupled to the hub module and the user computing device, the local computing device including a processor and a non-transitory, processor-readable storage medium including a computer readable and executable instruction set, which, when executed, causes the processor to receive a signal from the hub module indicative of a detected parameter of the manufacturing device, determine, based at least in part on the detected parameter of the manufacturing device, an improved parameter of the manufacturing device, and send a signal to the user computing device to provide an option implement the improved parameter on the manufacturing device.

In another embodiment, a method for managing a mechanized process includes receiving a signal from a hub module indicative of a detected parameter of a manufacturing device, determining with a local computing device communicatively coupled to the hub module, an improved parameter of the manufacturing device based at least in part on the detected parameter of the manufacturing device, and sending a signal to a user computing device to provide an option implement the improved parameter on the manufacturing device.

Additional features and advantages of the technology in this disclosure will be set forth in the detailed description which follows, and in part will be readily apparent to those skilled in the art from the description or recognized by practicing the technology as described in this disclosure, including the detailed description which follows, the claims, as well as the appended drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 depicts an example mechanized system, according to embodiments described herein;

FIG. 2 depicts a hub module for the mechanized system of FIG. 1, according to embodiments described herein;

FIG. 3 depicts a device communications module of the controller of FIG. 2, according to embodiments described herein;

FIG. 4 depicts a signal conditioner of the controller of FIG. 2, according to embodiments described herein;

FIG. 5 depicts another signal conditioner, according to embodiments described herein;

FIG. 6 depicts another signal conditioner, according to embodiments described herein;

FIG. 7A depicts a computing environment for the mechanized system of FIG. 1, according to embodiments described herein;

FIG. 7B depicts the controller of FIG. 2 communicating with sensors, according to embodiments described herein;

FIG. 8 depicts a user interface for configuring a device in a mechanized system, according to embodiments described herein;

FIG. 9 depicts a user interface for configuring sensors of a device of a mechanized system, according to embodiments described herein;

FIG. 10 depicts a user interface for providing the geographic location of devices of a mechanized system, according to embodiments described herein;

FIG. 11 depicts a user interface for providing sensor data, according to embodiments described herein;

FIG. 12 depicts a user interface for providing sensor data, according to embodiments described herein;

FIG. 13 schematically depicts a user interface for configuring a mechanized system, according to embodiments described herein.

Reference will now be made in greater detail to various embodiments, some embodiments of which are illustrated in the accompanying drawings. Whenever possible, the same reference numerals will be used throughout the drawings to refer to the same or similar parts.

### DETAILED DESCRIPTION

Embodiments disclosed herein include systems and methods for managing sensors and controlling actuators, transducers, pneumatics, and/or relays, where the systems are configured to work with existing infrastructure of mechanized systems.

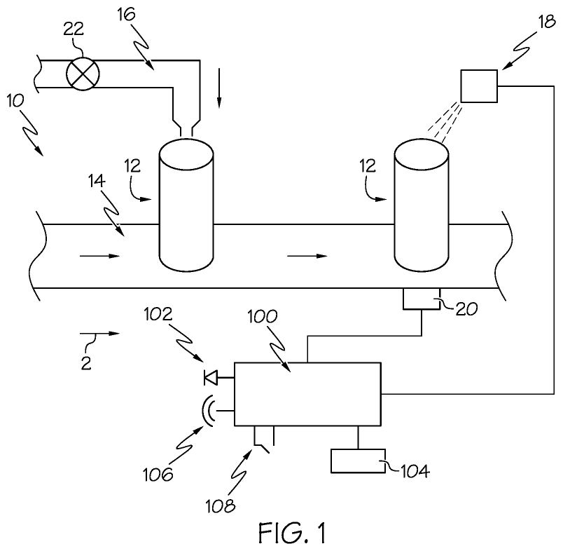

Sensors and actuators are used in a wide variety of manufacturing applications. For example and referring to FIG. 1, an example mechanized system 10 is depicted. In the example depicted in FIG. 1, the mechanized system 10 is a receptacle filling process, however, it should be understood that this is merely exemplary, and the concepts described herein can be applied to any suitable mechanized system.

In the mechanized system 10, receptacles 12 are conveyed along a conveyor 14. The mechanized system 10 includes a filling device 16 and a marker 18. As the receptacles 12 pass under the filling device 16, the filling device 16 fills the receptacles 12 with a product. For example, in some embodiments, the receptacles 12 may include bottles or the like that may be filled with a fluid and the mechanized system 10 may be a beverage production process. After passing the filling device 16, receptacles 12 move to a sensor 20. In the example depicted in FIG. 1, the sensor 20 includes a sensor configured to detect a weight of the receptacle 12, and may include a load cell or the like.

The sensor 20 is communicatively coupled to a hub module 100, such that the hub module 100 may receive signals from the sensor 20 and/or send signals to the sensor 20. In embodiments, the sensor 20 is communicatively coupled to the hub module 100 through a wired connection. In some embodiments, the sensor 20 is communicatively coupled to the hub module 100 by a wireless connection, as described in greater detail herein.

In some embodiments, the hub module 100 can be communicatively coupled to an actuator 22, either through a wired connection or a wireless connection. In the embodiment depicted in FIG. 1, the actuator 22 includes a valve or the like that is configured to selectively release product from the filling device 16. In embodiments, the hub module 100 can selectively direct the actuator 22 to increase or decrease the product released from the filling device 16, for example, in response to the detected weight of the receptacles 12 from the sensor 20. While the actuator 22 is depicted in FIG. 1, it should be understood that the hub module 100 may be communicatively coupled to and control any other suitable devices in a mechanized system 10, for example and without limitation transducers, relays, pneumatics, and the like.

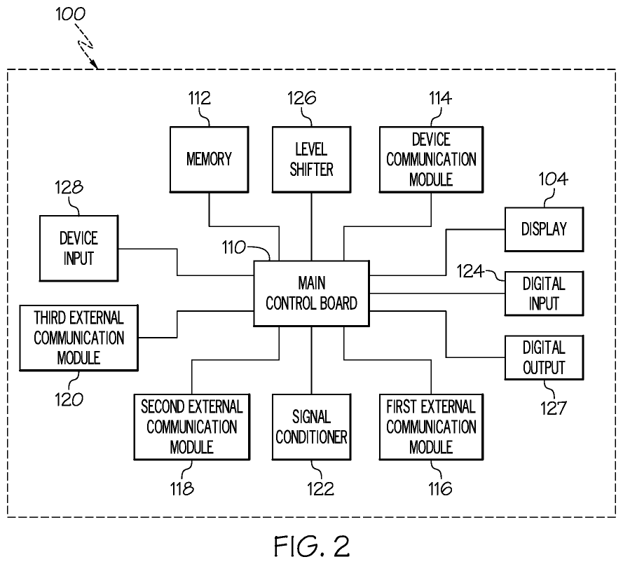

In embodiments, the hub module 100 may be utilized with existing mechanized systems without disrupting the operation of the mechanized system 10. For example and referring to FIG. 2, in embodiments, the hub module 100 generally includes a device input 128, a memory 112, a device communications module 114, a digital input 124, a digital output 127, a signal conditioner 122, and an external communications module 116. In some embodiments, the external communications module 116 is a first external communications module 116, and the hub module 100 may include one or more additional communications modules. For example, in the embodiment depicted in FIG. 2, the hub module 100 further includes a second external communications module 118, and a third external communication module 120. In some embodiments, the hub module 100 may include a level shifter 126, and/or a display 104. The hub module 100 further includes a main control board 110 that is communicatively coupled to the device input 128, the display 104, the memory 112, the level shifter 126, the device communications module 114, the digital input 124, the digital output 127, the signal conditioner 122, the first external communications module 116, the second external communications module 118, and the third external communication module 120. While each of the main control board 110 the device input 128, the display 104, the memory 112, the level shifter 126, the device communications module 114, the digital input 124, the digital output 127, the signal conditioner 122, the first external communications module 116, the second external communications module 118, and the third external communication module 120 are described and depicted as residing within the hub module 100, it should be understood that one or more of these components may be external to the hub module 100. While the embodiment depicted in FIG. 2 includes each of the first, second, and third external communications modules 116, 118, 120, it should be understood that this is merely an example, and in some embodiments, only a single external communications module is included.

The device input 128 generally includes an input communicatively connecting the hub module 100 to one or more sensors 20 (FIG. 1), such as optical sensors, electrical sensors, thermocouples, resistance temperature detectors (RTDs) or the like through a wired connection. For example, in one embodiment, the device input 128 may include an RS-485 cable connected to one or more sensors 20 (FIG. 1). In embodiments, the device input 128 is connected to the one or more sensors 20 (FIG. 1), and may receive signals (through a wireless or wired connection) from the sensors 20 (FIG. 1) without affecting the operation of the one or more sensors 20 (FIG. 1). Additionally, the device input 128 may receive signals from the one or more sensors 20 (FIG. 1) through a non-invasive connection, e.g., without interfering with the connection of the one or more sensors 20 (FIG. 1) to separate control structures of a manufacturing device, such as a PLC or the like, without interfering with the operation of the PLC. Likewise, the device input 128 may send and/or receive signals (through a wireless or wired connection) from the one or more actuators 22 (FIG. 1) through a non-invasive connection without affecting the operation of the one or more actuators 22 (FIG. 1). Additionally, the device input 128 may send and/or receive signals from the one or more actuators 22 (FIG. 1) through a non-invasive connection without interfering with the connection of the one or more actuators 22 (FIG. 1) to separate control structures of a manufacturing device, such as a PLC or the like.

In embodiments, the memory 112 may include volatile and/or non-volatile memory. In some embodiments, the memory 112 includes Electrically Erasable Programmable Read-Only Memory (EEPROM). In some embodiments, the memory 112 may be configured as volatile and/or nonvolatile memory and as such, may include random access memory (including SRAM, DRAM, and/or other types of RAM), flash memory, secure digital (SD) memory, registers, compact discs (CD), digital versatile discs (DVD), and/or other types of non-transitory computer-readable mediums. Depending on the particular embodiment, these non-transitory computer-readable mediums may reside within the main control board 110 and/or external to the main control board 110.

In embodiments, the level shifter 126 generally is a circuit used to translate signals from one logic level or voltage domain to another.

In embodiments, the first communication module 116 generally includes input/outputs that communicatively couple the hub module 100 to one or more other devices, such as through a wired connection, an Ethernet connection, an optical connection, or the like. In embodiments that include the second and/or third communications modules 118, 120, the second and/or third communications modules 118, 120 may perform similar functions. In embodiments, the first, second, and third external communications modules 116, 118, 120 may utilize different communication methodologies from one another, thereby providing redundancy and multiple avenues for the hub module 100 to communicate with other devices. By providing multiple communications modules (e.g., the first, second, and third external communications modules 116, 118, 120), the hub module 100 may communicate with other devices via multiple communications methodologies, thereby providing redundancy that assists in ensure the hub module 100 is capable of sending and receiving signals.

In the embodiment depicted in FIG. 2, the hub module 100 includes an isolated digital input 124. The digital input 124 may provide an additional user input, and may include an alpha-numeric keyboard, a graphical user interface (GUI), or the like.

In some embodiments and as shown in FIG. 2, the hub module 100 includes the digital output 127, isolated by way of an optocoupler or the like.

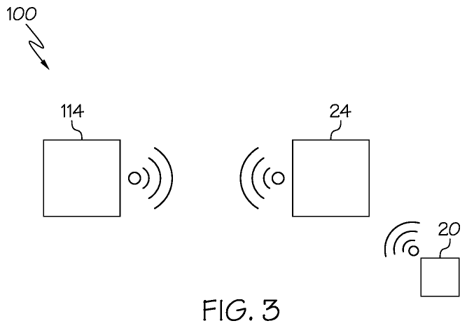

Referring collectively to FIGS. 2 and 3, the hub module 100 includes the device communications module 114. In embodiments, the device communications module 114 includes an antenna, a modem, LAN port, wireless fidelity (WI-FI) card, WiMax card, ZigBee card, Bluetooth chip, USB card, mobile communications hardware, and/or other hardware for communicating with other networks and/or devices. In embodiments, the device communications module 114 enables communication of the hub module 100 with a sensor 20. For example and as shown in FIG. 2, a sensor 20 is wirelessly connected to a broadcaster 24 that is communicatively coupled to the device communications module 114. In embodiments, the broadcaster 24 may be a remote ZigBee device that receives information from the sensor 20 and sends the information to the hub module 100 via the device communications module 114. In this way, the hub module 100 may receive information from sensors without requiring a wired connection to the one or more sensors 20 and/or actuators 22 (FIG. 1), which may assist in receiving information from sensors or actuators in which it would otherwise be difficult to provide a wired connection. In embodiments, information may be received from and transmitted by the broadcaster 24 at user-defined intervals.

Referring to FIGS. 2, 4, 5, and 6, the signal conditioner 122 is depicted. The signal conditioner 122 generally capacitively isolates, and transforms signals from the sensor 20 (FIG. 1) into a signal readable by the main control board 110. The signal conditioner 122 may further protect the one or more sensors 20 (FIG. 1) and/or one or more actuators 22 (FIG. 1) from noise interference, ground loop or otherwise.

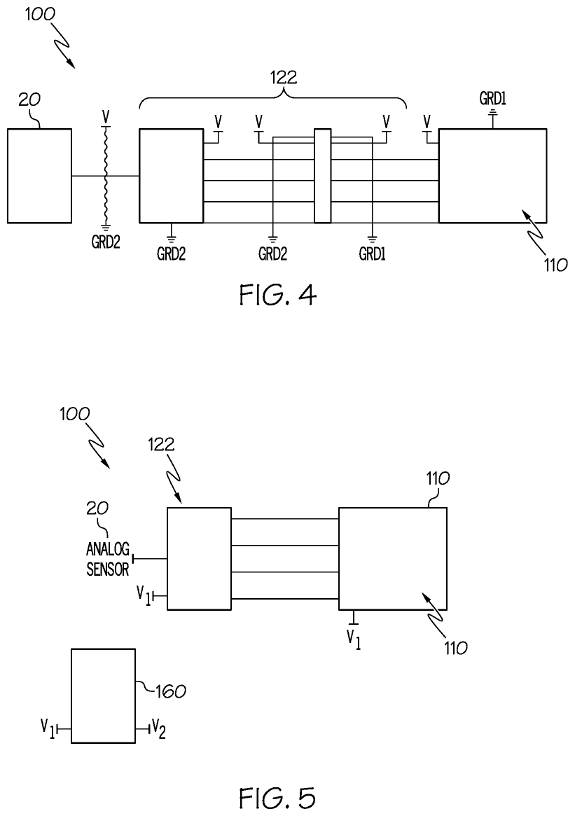

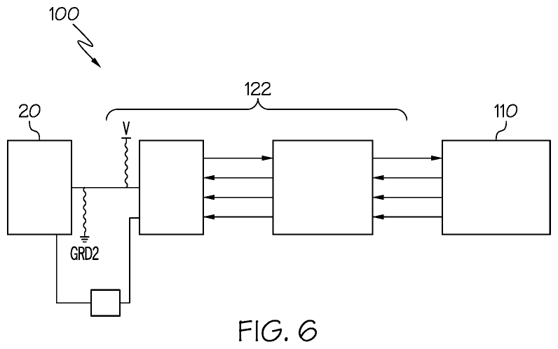

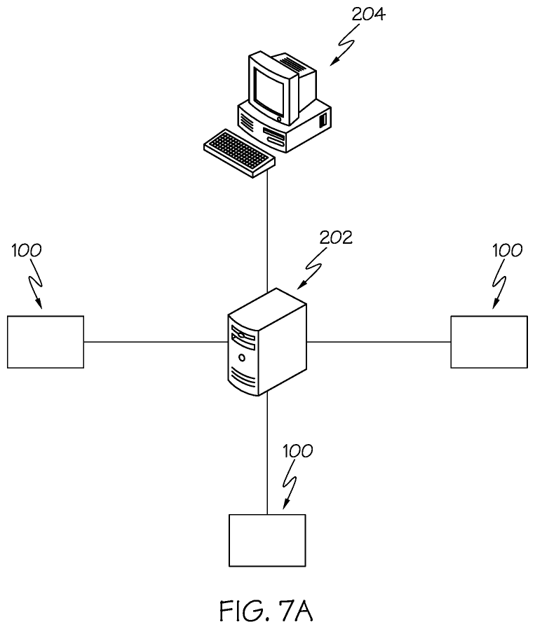

As shown in FIG. 4, the signal conditioner 122 can be configured to operate in a [symbol] bidirectional [symbol] manner (e.g., receiving signals from the sensor 20). As shown in FIG. 5, the signal conditioner 122 can be configured to operate in the unidirectional manner, and the hub module 100 may include an isolated power supply 160. As shown in FIG. 6, in some embodiments, the signal conditioner 122 can be configured to operate a [symbol] bi-directional [symbol] manner (e.g., receiving signals from the sensor 20 and sending signals to the sensor 20 and/or to one or more actuators 22 (FIG. 1)). In some embodiments, this isolated [symbol] bi-directional [symbol] signal is accomplished by way of optocoupler or the like. In these embodiments, the hub module 100 may act in a manner similar to a PLC to control the operations of a mechanized system.

Referring again to FIG. 2, the main control board 110 generally sends and/or receives data via the device input 128 which includes the signal conditioner 122, the device communications module 114, the first external communications module 116, and/or the digital input 124. The main control board 110 may include, for example and without limitation a processor including any processor operable to receive and execute instructions (such as from the memory 112).

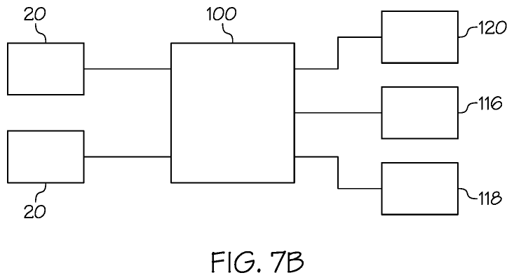

Referring to FIGS. 7A and 7B, the hub module 100 is communicatively coupled to a local computing device 202. For example, the hub module 100 may be communicatively coupled to the local computing device 202 via a wired connection, an Ethernet connection, an optical connection, or the like. The local computing device 202 may include a server, personal computer, tablet, phablet, mobile device, etc. and may be utilized for machine to machine communications, for example between one or more hub modules 100 and a user computing device 204, and/or between different hub modules 100. The user computing device 204 may include a personal computer, laptop, mobile device, tablet, phablet, server, etc. and may be utilized as an interface with a user. As an example, a user may monitor a sensor 20 (FIG. 1) or actuate an actuator 22 (FIG. 1) via the user computing device 204. Another example may include the hub module 100 sending notifications to a user via the user computing device 204. In some embodiments, the local computing device 202 may be disconnected from external communications, for example, the internet, and may only be connected via a local connection, thereby reducing the risk of compromising data within the local computing device 202.

As shown in FIG. 7B, the hub module 100 may connect to the local computing device 202 (FIG. 7A) via a wired connection, an Ethernet connection, an optical connection, or the like.

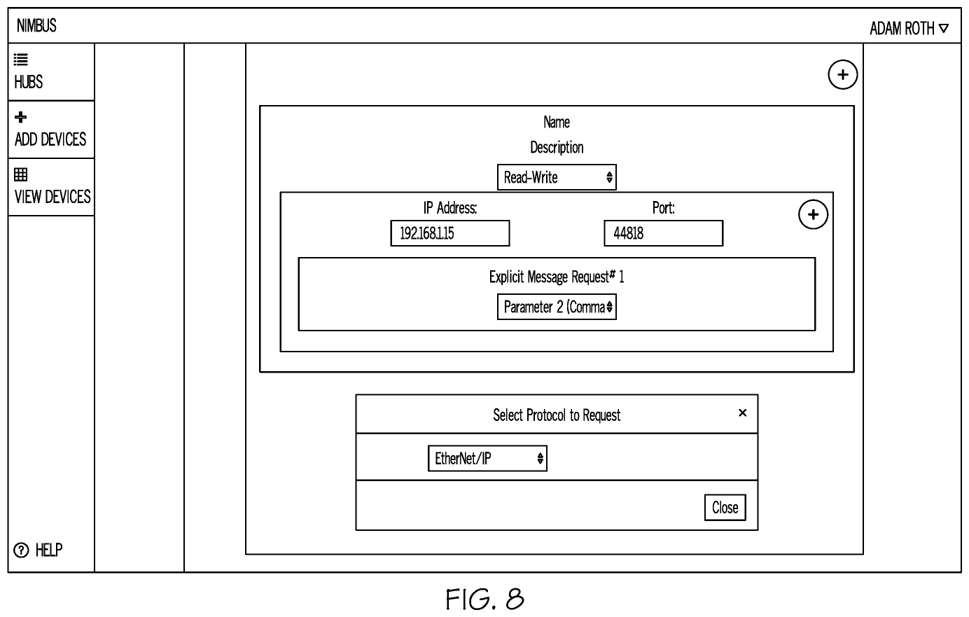

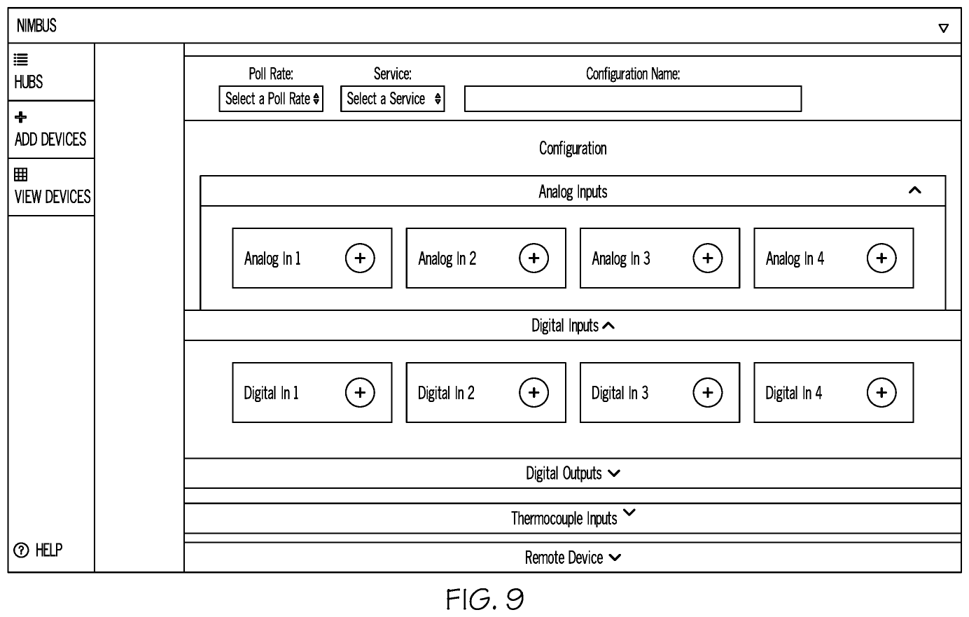

Referring to FIGS. 8 and 9, graphical displays, such as those that may be displayed by a desktop app on the user computing device 204 (FIG. 7A) are depicted. As shown in FIG. 8, users may configure a hub to communicate to various devices, such as sensors or PLCs, (e.g., hub modules 100 (FIG. 7A)), and as shown in FIG. 9, users may configure hub modules to communicate to sensors 20 and/or actuators 22 within their systems over various communication methods, such as analog signal, digital signal, industrial ethernet and/or hardwired communication protocols, such as EtherNet/IP, PROFINET, Modbus RTU or the like. In embodiments, users may select various characteristics, for example, a desired poll rate for the sensors 20 and/or actuators. In embodiments, access to hub configuration and/or information relating to a hub or a user [symbol] s sensors 20 and/or actuators 22 via the hub module 100 may be restricted, such as by password protection, digital keys, biometric verification, or the like. While the embodiment depicted in FIGS. 8 and 9 shows the configuration of a hub to communicate to sensors, it should be understood that actuators 22 (FIG. 2) within a user [symbol] s mechanized system may be configured in a similar manner through the user computing device 204 (FIG. 7A) through a similar graphical display/user interface.

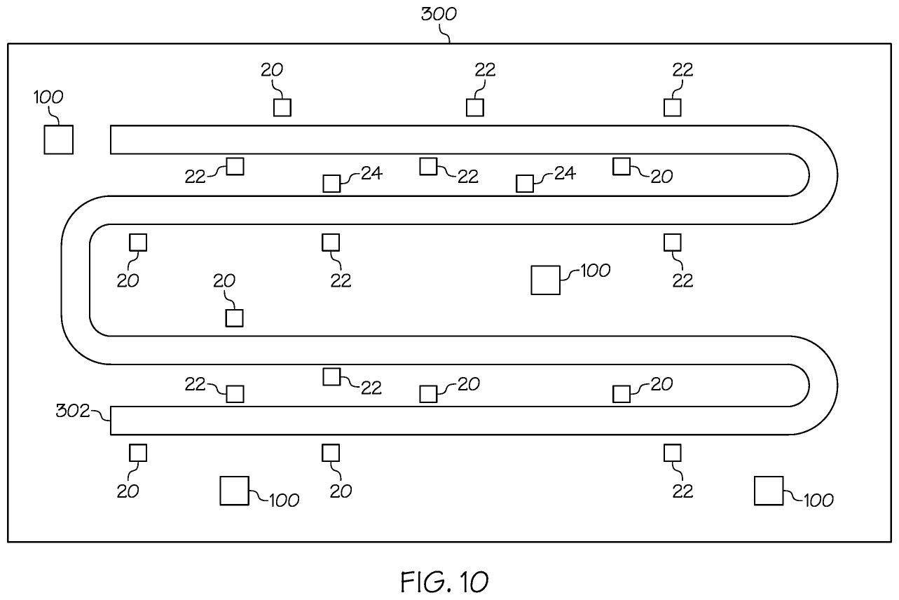

Referring to FIG. 10, another graphical display, such as may be presented via a desktop app on the user computing device 204 (FIG. 7A) is schematically depicted. In the example depicted in FIG. 10, the geographical position of one or more sensors 20 and/or one or more actuators 22 within a facility 300 are schematically depicted. In particular, in the example depicted in FIG. 10, an overhead view of a manufacturing process, such as a vehicle assembly process, is depicted. One or more sensors 20 and/or one or more actuators 22 may be positioned along an assembly line 302, and the one or more sensors 20 and/or one or more actuators 22 may be communicatively coupled to hub modules 100. The hub modules 100, via the local computing device 202 (FIG. 7A) can communicate the physical location of the one or more sensors 20 and/or the one or more actuators 22 to the user computing device 204, providing a user with a real-time status of different sensors 20 and/or actuators 22 throughout the facility 300. By providing the user with the position of the sensors 20 and/or actuators 22, upon the detection of an issue with any of the sensors and/or actuators 22, technicians can be dispatched to correct locations within the facility 300 to implement appropriate countermeasures. In some embodiments, the hub modules 100 may be interchangeable with one another, and can be selectively communicatively coupled to and selectively disconnected from each of the one or more sensors 20 and/or the one or more actuators 22. In other words, the hub module 100 may be portable within the facility 300, and can be moved throughout the facility 300 to meet data collection and optimization needs of processes or subsets of processes within the facility 300.

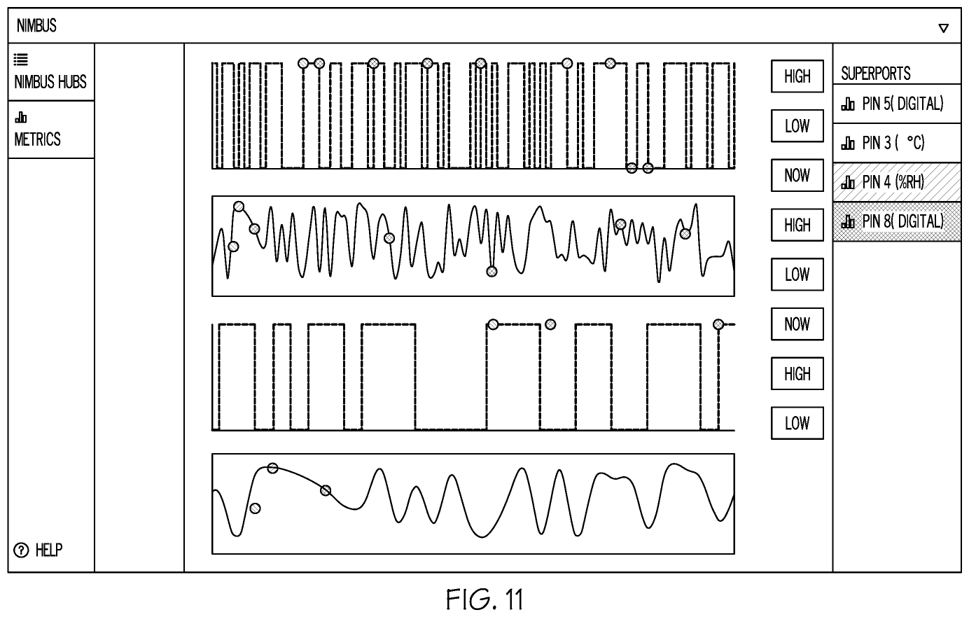

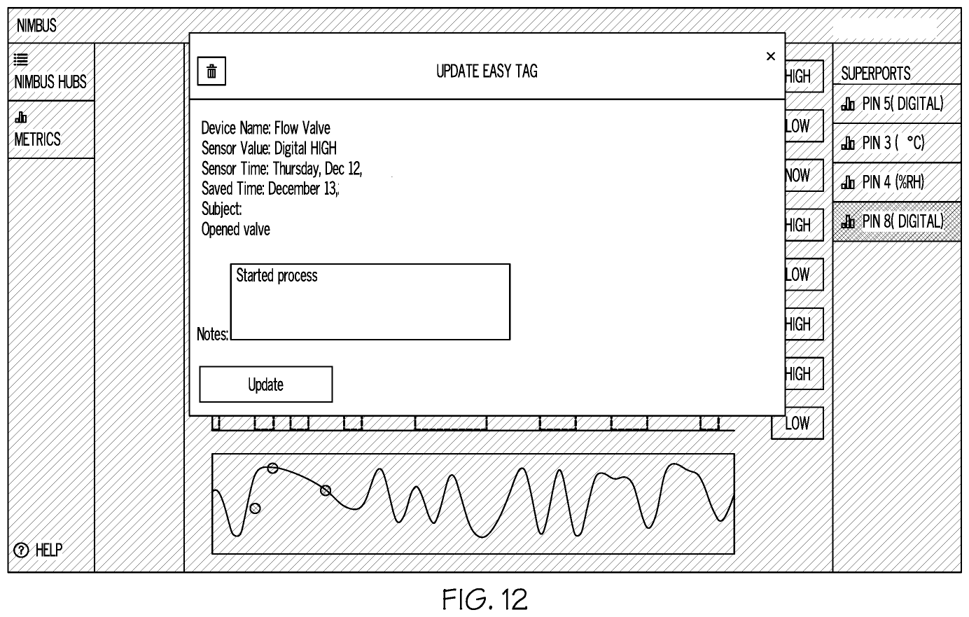

Referring to FIGS. 11 and 12, output from sensors 20 and/or parameters from devices (via industrial communication protocols), such as may be displayed via a desktop app on the user computing device 204 (FIG. 7A) are depicted. In the example shown in FIGS. 11 and 12, the sensors 20 include temperature sensors, and detected temperatures are shown as a function of time. While the output depicted in FIGS. 11 and 12 includes detected temperatures, any suitable metric detected by a sensor 20 may be depicted (e.g., weight, humidity, etc.). In embodiments, the output of multiple sensors 20 may be overlaid, allowing a user to visualize and understand the causes and effects of conditions across various incoming data streams within a facility as a function of time.

As shown in FIGS. 11 and 12, anomalies or large changes in detected metrics may be displayed via a desktop app on the user computing device 204 (FIG. 7A). In some embodiments, the user computing device 204 (FIG. 7A) is configured to receive input from a user to [symbol] mark [symbol] different data points, as shown in FIG. 12. More particularly, a user may mark or make notes via the user computing device 204 (FIG. 7A) to analyze potential causes or effects of the data points. For example, a user may determine that the large changes in detected temperature are associated with desirable or undesirable operation (e.g., increased or decreased product quality). The user computing device 204 (FIG. 7A) may receive input from the user to mark the increased temperature data points, which may assist in correlating data to improve the operation of a mechanized system.

Moreover, in embodiments, the user computing device 204 (FIG. 7A) may receive configurable thresholds of various parameters of the one or more sensors 20 and/or the one or more actuators 22. For example, in some embodiments, the one or more sensors 20 and/or the one or more actuators 22 may have associated configurable thresholds, and upon detection that the one or more sensors 20 and/or the one or more actuators 22 exceed the configurable threshold, alarms or alerts can be provided via the user computing device 204 (FIG. 7A). For example, in one example, the one or more sensors 20 may include temperature sensors, and the configurable threshold may be associated with maximum and/or minimum allowable temperatures associated with the one or more sensors 20. Upon receiving a signal from the one or more sensors 20 (e.g., via the hub module 100 and the local computing device 202), an alarm or alert may be provided via the user computing device 204.

In some embodiments, one or both of the local computing device 202 (FIG. 7A) and the user computing device 204 (FIG. 7A) may be equipped with machine learning algorithms and/or analytic algorithms. For example, in some embodiments, the local computing device 202 (FIG. 7A) and/or the user computing device 204 (FIG. 7A) may perform simulations of a manufacturing processes, and may determine improved parameters (e.g., temperature values, harmonic values, or the like) of the one or more sensors 20 (FIG. 1) and/or the one or more actuators 22 (FIG. 1). In some embodiments, the local computing device 202 (FIG. 7A) and/or the user computing device 204 (FIG. 7A) may perform analytics on historical data received from the one or more sensors 20 (FIG. 1) and/or the one or more actuators 22 (FIG. 1) to determine improved parameters (e.g., temperature values, harmonic values, or the like). The improved parameters can be provided to the user computing device

In embodiments, the localized nature of the local computing device 202 (FIG. 7A) may simplify the determination of improved parameters (e.g., machine learning). Data preprocessing for analytics, a usually cumbersome and difficult process that requires specialized knowledge, is automated to collect and format data in local computing device 202 (FIG. 7A). For example, conventional manufacturing systems may include distributed information systems, making it difficult and cumbersome to determine improved parameters for different manufacturing processes. By contrast, because data associated with all of the manufacturing processes within a manufacturing environment are consolidated and stored within a common local computing device 202 (FIG. 7A), the determination of one or more improved parameters is simplified, and may be accomplished without requiring specialized knowledge.

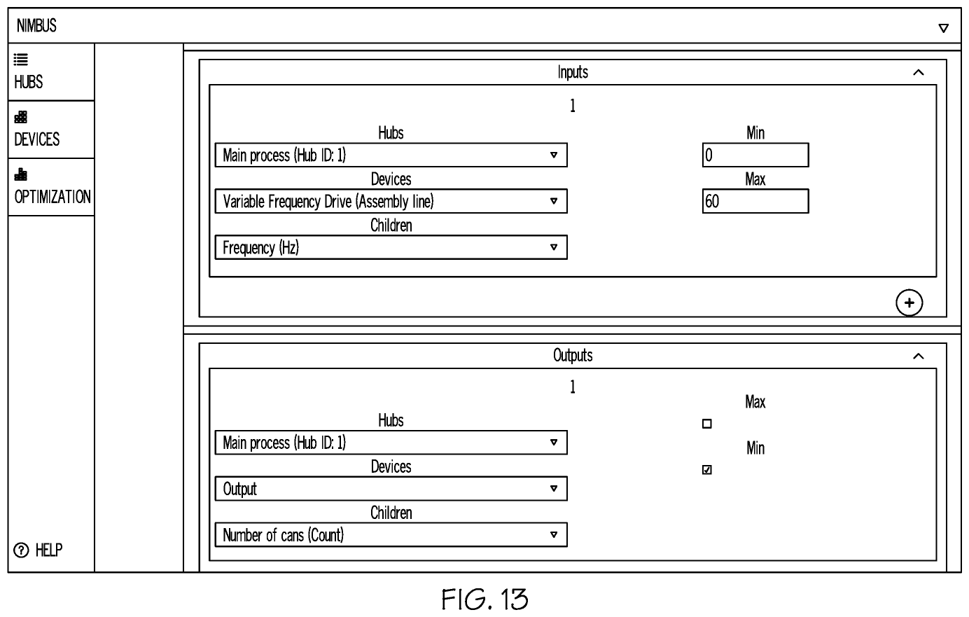

Referring to FIG. 13, a user may configure any number of optimization inputs in the sequential order of data collected in the mechanized system, such as the system depicted in FIG. 1, in conjunction with corresponding minimum and maximum physical constraints. Moreover, a user may configure any number of optimization outputs, in order of importance, as well as the objective to minimize or maximize that particular optimization parameter. After the optimization configuration is generated, these configured instructions may be sent to the local computing device 202 (FIG. 7A) for executing machine learning algorithms and/or analytic algorithms which return results of optimized parameters to the user. For example, in some embodiments, the improved parameter determined by the local computing device 202 (FIG. 7A) may be associated with the minimization or maximization of a user-selected output data stream and/or may be associated with a user-selected parameter.

While particular embodiments and aspects of the present disclosure have been illustrated and described herein, various other changes and modifications can be made without departing from the spirit and scope of the disclosure. Moreover, although various aspects have been described herein, such aspects need not be utilized in combination. Accordingly, it is therefore intended that the appended claims cover all such changes and modifications that are within the scope of the embodiments shown and described herein.

It should now be understood that embodiments disclosed herein are directed to systems for sensor monitoring and actuator/transducer/relay/pneumatics control, where the systems are configured to work with existing infrastructure of mechanized systems. It should also be understood that these embodiments are merely exemplary and are not intended to limit the scope of this disclosure.

Having described the subject matter of the present disclosure in detail and by reference to specific embodiments, it is noted that the various details described in this disclosure should not be taken to imply that these details relate to elements that are essential components of the various embodiments described in this disclosure, even in cases where a particular element is illustrated in each of the drawings that accompany the present description. Rather, the appended claims should be taken as the sole representation of the breadth of the present disclosure and the corresponding scope of the various embodiments described in this disclosure. Further, it should be apparent to those skilled in the art that various modifications and variations can be made to the described embodiments without departing from the spirit and scope of the claimed subject matter. Thus it is intended that the specification cover the modifications and variations of the various described embodiments provided such modification and variations come within the scope of the appended claims and their equivalents.

It is noted that recitations herein of a component of the present disclosure being “structurally configured” in a particular way, to embody a particular property, or to function in a particular manner, are structural recitations, as opposed to recitations of intended use. More specifically, the references herein to the manner in which a component is “structurally configured” denotes an existing physical condition of the component and, as such, is to be taken as a definite recitation of the structural characteristics of the component.

It is noted that terms like [symbol] preferably, [symbol] [symbol] commonly, [symbol] and [symbol] typically, [symbol] when utilized herein, are not utilized to limit the scope of the claimed invention or to imply that certain features are critical, essential, or even important to the structure or function of the claimed invention. Rather, these terms are merely intended to identify particular aspects of an embodiment of the present disclosure or to emphasize alternative or additional features that may or may not be utilized in a particular embodiment of the present disclosure.

For the purposes of describing and defining the present invention it is noted that the terms [symbol] substantially [symbol] and [symbol] about [symbol] are utilized herein to represent the inherent degree of uncertainty that may be attributed to any quantitative comparison, value, measurement, or other representation. The terms [symbol] substantially [symbol] and [symbol] about [symbol] are also utilized herein to represent the degree by which a quantitative representation may vary from a stated reference without resulting in a change in the basic function of the subject matter at issue.

It is noted that one or more of the following claims utilize the term [symbol] wherein [symbol] as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term [symbol] comprising.

[symbol]

What is claimed is:

1. A modular system for managing and optimizing operation of a mechanized process, the modular system comprising:
a hub module structurally configured to be non-invasively communicatively coupled to a manufacturing device;
a user computing device; and
a local computing device communicatively coupled to the hub module and the user computing device, the local computing device comprising a processor and a non-transitory, processor-readable storage medium comprising a computer readable and executable instruction set, which, when executed, causes the processor to:
receive a signal from the hub module indicative of a detected parameter of the manufacturing device;
determine, based at least in part on the detected parameter of the manufacturing device, an improved parameter of the manufacturing device; and
send a signal to the user computing device to provide an option implement the improved parameter on the manufacturing device.

2. The modular system of claim 1, wherein the computer readable and executable instruction set, when executed, further causes the processor to send a signal to the user computing device indicative of the detected parameter of the manufacturing device.

3. The modular system of claim 2, wherein the computer readable and executable instruction set, when executed, further causes the processor to:
determine whether the detected parameter is within a configurable threshold; and
provide an alarm to the user computing device in response to determining that the detected parameter is outside the configurable threshold.

4. The modular system of claim 3, wherein the configurable threshold is based at least in part on a user input received via the user computing device.

5. The modular system of claim 1, wherein the computer readable and executable instruction set, when executed, further causes the processor to perform a simulation of the manufacturing device to determine the improved parameter.

6. The modular system of claim 1, wherein the computer readable and executable instruction set, when executed further causes the processor to store detected parameters of the manufacturing device, and wherein the improved parameter is based at least in part on the stored detected parameters.

7. The modular system of claim 1, wherein the manufacturing device comprises at least one of a sensor and an actuator.

8. The modular system of claim 1, wherein the computer readable and executable instruction set, when executed, further causes the processor to:
display via the user computing device, a graphical display of the detected parameter of the manufacturing device; and
receive a user input via the user computing device to mark the detected parameter of the manufacturing device.

9. The modular system of claim 1, wherein the improved parameter is an optimized parameter.

10. The modular system of claim 1, wherein the computer readable and executable instruction set, when executed, further causes the processor to implement the improved parameter.

11. A method for managing a mechanized process, the method comprising:
receiving a signal from a hub module indicative of a detected parameter of a manufacturing device;
determining with a local computing device communicatively coupled to the hub module, an improved parameter of the manufacturing device based at least in part on the detected parameter of the manufacturing device; and
sending a signal to a user computing device to provide an option implement the improved parameter on the manufacturing device.

12. The method of claim 11, further comprising sending a signal to a user computing device, via the local computing device, the signal indicative of the detected parameter of the manufacturing device.

13. The method of claim 11, further comprising:
determining whether the detected parameter is within a configurable threshold; and
providing an alarm to a user computing device communicatively coupled to the local computing device in response to determining that the detected parameter is outside the configurable threshold.

14. The method of claim 13, wherein the configurable threshold is based at least in part on a user input received via the user computing device.

15. The method of claim 11, further comprising performing a simulation of the manufacturing device to determine the improved parameter.

16. The method of claim 11, further comprising storing detected parameters of the manufacturing device, and wherein the improved parameter is based at least in part on the stored detected parameters.

17. The method of claim 11, wherein the manufacturing device comprises at least one of a sensor and an actuator.

18. The method of claim 11, further comprising:
displaying via a user computing device communicatively coupled to the local computing device, a graphical display of the detected parameter of the manufacturing device; and
receiving a user input via the user computing device to mark the detected parameter of the manufacturing device.

19. The method of claim 11, wherein the detected parameter is a detected temperature.

20. The method of claim 11, further comprising implementing the improved parameter.
